(19) United States
(12) Patent Application Publication
(10) Pub. No.: US 2026/0288102 A1
(43) Pub. Date: Sep. 24, 2026

(54) PROCESS AUTOMATION SERVER PRIORITIZATION

(71) Applicant: Yokogawa Electric Corporation, TOKYO (JP)

(72) Inventors: Patrick Clay, Frisco, TX (US); Vien Nguyen, Frisco, TX (US); Andrew Keller, Lewisville, TX (US); Rabi Gurung, Calgary, CA (US)

(21) Appl. No.: 19/087,794

(22) Filed: Mar. 24, 2025

(51) Int. Cl. G05B 19/042; H04L 47/24

(52) U.S. Cl. CPC G05B 19/0423; H04L 47/24

(57) ABSTRACT

Implementations disclosed herein are directed to process automation server prioritization. In various implementations, a first priority may be assigned to a first subscriber process that subscribes to one or more input/output (I/O) channels managed by a platform-independent server hosted by a distributed control node (DCN) of a process automation facility, the one or more I/O channels including one or more of a sensor or an actuator. A second priority may be assigned to a second subscriber process that subscribes to one or more of the I/O channels hosted by the platform-independent server hosted by the DCN, the second priority being lower than the first priority. In response to determining that the server is experiencing performance degradation, interaction of the platform-independent server with the first subscriber process may be prioritized over the second subscriber process, based on the first and second priorities.

### BACKGROUND

Process automation facilities extensively utilize distributed control nodes (DCNs) to manage a wide array of input/output (I/O) components such as sensors, actuators, and function blocks, to name a few. Access to these I/O components is often facilitated through process automation facilities that leverage Open Platform Communications Unified Architecture (OPC UA) servers, where DCNs host resources like I/O channels coupled with sensors and actuators. Each resource is commonly associated with an alias to simplify the configuration and management of these process automation networks. Process automation facilities often rely on OPC UA servers to manage access to I/O channels of DCNs. When an OPC UA server becomes overloaded or its performance otherwise degrades, all subscribing clients are impacted equally, regardless of their importance. This can lead to failures in critical process control loops, resulting in downtime, accidents, reduced quality of service (QoS), and other negative consequences.

Consider a scenario in a large-scale chemical plant. One client, critical for maintaining reactor temperature within a safe operating range, relies on a particular temperature sensor’s readings. Concurrently, another client performs non-critical data logging using a pressure sensor’s readings. If the OPC UA server managing these sensors experiences a sudden surge in subscriptions, like a system-wide diagnostic routine, both clients are affected equally. The data logging client might simply experience delayed readings, but the temperature control loop could fail, leading to a potentially dangerous runaway reaction. Another challenge arises when device aliases need to be remapped due to migration or system maintenance activity; there is no way to prioritize which clients have first access to these resources.

### SUMMARY

Implementations disclosed herein are directed to assigning a first priority to a first subscriber process (e.g., an OPC UA client and/or a function block) that subscribes to one or more I/O channels managed by a platform-independent (or “cross-platform”) server hosted by a DCN of a process automation facility. A second priority is assigned to a second subscriber process that subscribes to one or more of the I/O channels hosted by the platform-independent server hosted by the distributed control node, and the second priority is lower than the first priority. When the platform-independent server is determined to be experiencing a degradation in performance, and based on the first and second priorities, interaction of the platform-independent server with the first subscriber process is prioritized over the second subscriber process. For example, the first subscriber process might use data to control an actuator in a process control loop, while the second subscriber process might use data for debugging. When the OPC UA server experiences performance degradation, it prioritizes interaction with the first subscriber process over the second based on their assigned priorities.

Priorities can be binary (high/low) or range-based, allowing for more nuanced handling of service degradation. Subscribers can self-assign priorities based on their role, or the OPC UA server can assign priorities to its subscribers (“subscriber” and “subscriber process” will be used interchangeably herein). Overrides of assigned priorities may also be implemented. Function blocks subscribing to resources can also assign priorities based on their roles in the process automation facility, policing their own behavior by throttling calls or dropping connections during system degradation.

This prioritization can be implemented in several ways. The OPC UA server may close the network connection to the lower-priority subscriber, throttle network traffic to or from the lower-priority subscriber, or delay processing read/write requests from the lower-priority subscriber until after processing requests from the higher-priority subscriber. Alternatively, the lower-priority subscriber may be configured to refrain from sending further read/write requests until the server degradation is resolved.

The determination of performance degradation can be based on factors such as the number of network connections exceeding a threshold or the frequency of read/write requests from a subscriber exceeding a threshold. Performance can alternatively be detected using one or more machine learning and/or artificial intelligence (AI) models. For example, one or more machine learning models trained on a library or collection of previously received sensor readings may be implemented to detect when a number or frequency of sensor readings from a DCN exceeds a threshold that indicates performance degradation. Additionally or alternatively, a large language model (LLM) could be trained or fine-tuned to generate performance alerts when its corresponding data model detects a degradation in performance.

As a non-limiting example of some implementations disclosed herein, consider a chemical plant where a DCN controls the flow of reactants into a mixing tank. The DCN hosts an OPC UA server managing access to a flow sensor and an actuator valve. A first subscriber process, part of a critical process control loop, continuously monitors the flow rate via the sensor and adjusts the valve to maintain the desired reactant ratio. This process is assigned a high priority. Simultaneously, a second subscriber process, used for diagnostic purposes, periodically samples the flow rate data for analysis and troubleshooting. This process is assigned to be a lower priority. If the OPC UA server on the DCN becomes overloaded due to a sudden surge in network traffic or an increase in the frequency of diagnostic requests, the server will prioritize communication with the first subscriber process, ensuring the critical process control loop remains stable. The server might throttle or even temporarily disconnect the second, lower-priority subscriber process to maintain the responsiveness of the critical control loop, preventing potential disruptions in the chemical reaction.

Prioritizing subscribers as described herein offers significant technical advantages. By giving preference to critical subscribers, the system ensures that process control loops reliant on their data maintain a higher quality of service (QoS). For example, by prioritizing network traffic using QoS mechanisms for high-priority subscribers, the system can reduce latency, improve reliability, and minimize data loss for these critical components. The system may also prioritize which packets should be evaluated and dealt with, or how many read/write calls can be afforded. This results in more stable and responsive process control, thereby decreasing the potential for failures, reducing downtime, preventing accidents, and overall contributing to a safer and more efficient process automation environment.

### BRIEF DESCRIPTION OF THE DRAWINGS

FIG. 1 shows an example environment including a process automation management system, a process automation network, and multiple distributed control nodes.

FIG. 2 schematically depicts an example of how techniques described herein may be implemented.

FIG. 3 depicts an example method for practicing selected aspects of the present disclosure.

FIG. 4 is a block diagram of an example computer system.

### DETAILED DESCRIPTION

Implementations disclosed herein are directed to assigning a first priority to a first subscriber process. The first subscriber process subscribes to one or more I/O channels managed by a platform-independent server hosted by a DCN of a process automation facility and the I/O channels include sensors or actuators. A second priority is assigned to a second subscriber process that subscribes to one or more of the same I/O channels, where the second priority is lower than the first priority. The platform-independent server is determined to be experiencing a degradation in performance, and in response, interaction of the platform-independent server with the first subscriber process is prioritized over the second subscriber process based on the first and second priorities.

Implementations disclosed herein can mitigate (e.g., eliminate) various drawbacks with current techniques. For example, the assigned priorities ensure that critical process control loops continue to function even when the OPC UA server is under duress, mitigating downtime, accidents, and other negative consequences. As another example, clients using data for non-mission-critical applications such as debugging can gracefully be disconnected or throttled back, ensuring the clients that assist in controlling process loops are not impacted. As another example, the ability for subscribing clients or OPC UA servers to assign or override priorities enables a flexible and adaptable system that can cater to various process automation facility needs.

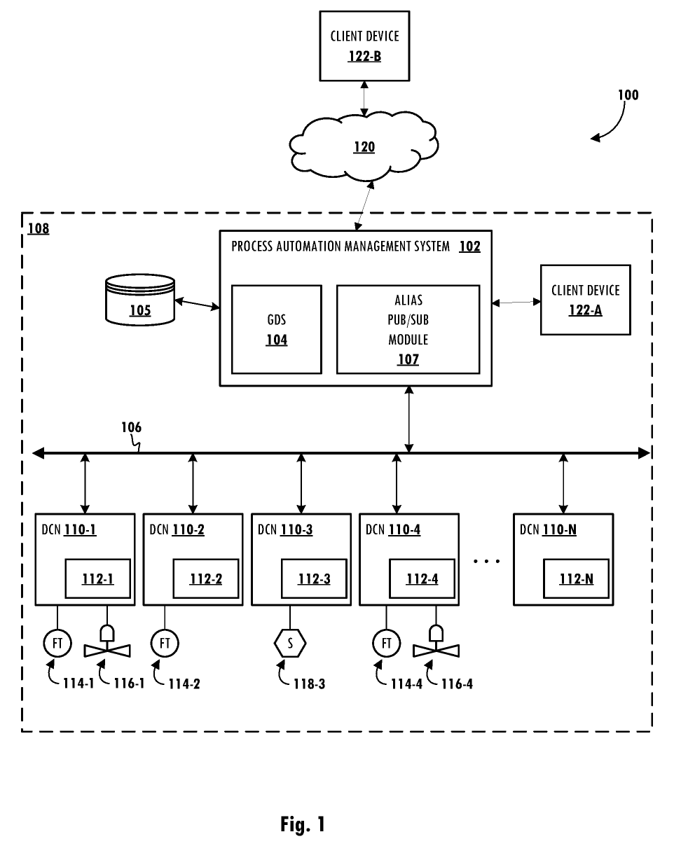

Referring now to FIG. 1, an example environment 100 in which various aspects of the present disclosure may be implemented is depicted schematically. A process automation management system 102 is operably coupled with a process automation network in a process automation facility 108. Process automation facility 108 may take numerous forms and may be designed to implement any number of at least partially automated processes. For example, process automation facility 108 may take the form of a chemical processing plant, an oil or natural gas refinery, a catalyst factory, a manufacturing facility, a pharmaceutical manufacturing facility, an offshore oil platform, etc .

Process automation network 106 may be implemented using various wired and/or wireless communication technologies. Process automation is often employed in scenarios in which the cost of failure tends to be large, both in human safety and financial cost to stakeholders. Accordingly, in various implementations, process automation network 106 may be configured with redundancies and/or backups to provide high availability (HA) and/or high quality of service (QoS).

In various implementations, process automation network 106 may include one or more networks based on the Institute of Electrical and Electronics Engineers (IEEE) 802.3 standard, such as Gigabit Ethernet and/or 10-Gigabit Ethernet. Process automation network 106 may also, or instead, include one or more networks based on the IEEE 802.11 (Wi-Fi) and/or IEEE 802.16 (WiMAX) standards. Process automation network 106 may also, or instead, include one or more networks based on the IEEE 802.20 standard, commonly referred to as “Mobile Broadband Wireless Access.” Process automation network 106 may also, or instead, include one or more networks based on the 3rd Generation Partnership Project (3GPP) Long Term Evolution (LTE) and/or 4G/5G standard protocols. Process automation network 106 may also, or instead, include one or more wired and/or wireless proprietary networks; one or more wired and/or wireless local area networks (LANs), such as an IEEE 802.11 network; and/or one or more wired and/or wireless wide area networks (WANs), such as a cellular data network and/or the Internet. Process automation network 106 may also, or instead, include one or more machine-to-machine networks.

Components of FIG. 1 may additionally or alternatively be implemented on a mesh network, offering several advantages. A mesh network's distributed architecture can enhance resilience against single points of failure, ensuring continued operation even if some network nodes become unavailable. Furthermore, distributing various processes such as function blocks across multiple nodes in a mesh network can reduce latency by minimizing the distance data must travel, leading to faster response times for OPC UA clients. The inherent redundancy of a mesh network can also improve the overall reliability and scalability of process automation facility 108.

In some implementations, process automation system 102 may include a GDS 104, an optional alias publication-subscribe (pub/sub) module 107, and a database 105 that stores information used by GDS 104 and/or alias pub/sub module 107. Various aspects of process automation management system 102, such as GDS 104 and/or alias pub/sub module 107, may be implemented using any combination of hardware and software. In some implementations, process automation management system 102 may be implemented across multiple computer systems as part of what is often referred to as a “cloud infrastructure” or simply the “cloud.” However, this is not required, and in FIG. 1, for instance, process automation management system 102 is implemented within process automation facility 108, e.g., in a single building or across a single campus of buildings or other industrial infrastructure. In such an implementation, process automation management system 102 may be implemented on one or more local computing systems, such as on one or more server computers.

In addition to process automation management system 102, a variety of other nodes are operably coupled with process automation network 106. In FIG. 1, for instance, N (positive integer) DCNs 110-1 to 110-N are operably coupled with process automation network 106. Each DCN may include circuitry or logic 112 that may take various forms, such as processor(s) that execute instructions in memory, a field-programmable gate array (FPGA), an application-specific integrated circuit (ASIC), and so forth. Each DCN 110 may have a particular role to play in process automation network 106. “Compute” DCNs may, for instance, control a process loop (e.g., a chemical process loop) in which various “field” devices (e.g., devices having sensors and/or actuators) interface with each other to perform some number of function control blocks (FBs).

While not depicted in FIG. 1, in various implementations, each DCN may execute a “platform-independent” or “cross-platform” server that orchestrates access to the DCN’s constituent I/O channels. In some cases, this cross-platform server may take the form of an OPC UA server. Additionally or alternatively, each DCN may operate a cross-platform client that is configured to subscribe to I/O channels (e.g., made accessible by the aforementioned cross-platform server) in order to receive information needed for the DCN to perform some function. In some cases, this cross-platform client may take the form of an OPC UA client.

Each DCN 110 may have various I/O components, which are accessible as “channels,” and which dictate at least some of its operational technology (OT) capabilities and, more generally, its role at process automation facility 108. For example, first DCN 110-1 includes a flow transmitter (FT) component 114-1 and an actuator (e.g., a valve) 116-1. In some implementations, a software component (e.g., a function block) implemented on DCN 110-1 (or any other DCN mentioned herein) may transform an analog signal to digital; and/or convert the signal between different units of measurement, for instance.

In addition, in some implementations, a software component (e.g., a function block) implemented on DCN 110-1 may be configured to translate data between various protocols. For example, a particular vendor’s DCN (or other legacy device) may not be configured natively to communicate data using the OPC UA. In some such implementations, another DCN 110 may be deployed to translate this data from the vendor’s proprietary format to OPC UA. Some such DCNs 110 may be referred to as “gateways” or “bridges” because they form a link between legacy technology and standards such as OPC UA.

Actuator 116-1 (and other actuators described herein) may be any electric, hydraulic, mechanical, and/or pneumatic component that is controllable to affect some aspect of a process automation workflow that occurs at process automation facility 108. In many cases, an actuator 116 may perform its function in response to various signals, such as sensor signals or commands from compute DCNs (which themselves may monitor for sensor signals). Some non-limiting examples of actuators 116 include, but are not limited to, valves, pistons, rotors, switches, heaters, coolers, stirrers, injectors, devices to create vacuums, belts, tracks, gears, grippers, motors, relays, servomechanisms, etc.

Each DCN 110 may have different OT capabilities with respect to one or more (e.g., all) other DCNs 110. In FIG. 1, for instance, second DCN 110-2 includes an FT component 114-2 but no actuator. Third DCN 110-3 includes a sensor 118-3 but no actuator. Sensor 118-3 (and elsewhere herein) may take various forms, including but not limited to a pressure sensor, a temperature sensor, a flow sensor (e.g., FT component 114), various types of proximity sensors, a light sensor (e.g., a photodiode), a pressure wave sensor (e.g., microphone), a humidity sensor (e.g., a humistor), a radiation dosimeter, a laser absorption spectrograph (e.g., a multi-pass optical cell), and so forth. Like first DCN 110-1, fourth DCN 110-4 also includes both an FT component 114-4 and an actuator 116-4.

Unlike DCNs 110-1 to 110-4, DCN 110-N does not include any I/O (actuators or sensors) components. Instead, DCN 110-N may be a “compute only” DCN whose role is to facilitate cooperation between itself and one or more other DCNs 110 on process automation network 106 to implement an at least partially automated process. For example, DCN 110-N may control a single process loop (e.g., a chemical process control loop) that involves one or more other DCNs 110. In some cases, a compute DCN 110 may perform a role similar to an autopilot on an airplane—the compute DCN 110 may receive various signals and, based on those signals and various criteria and/or thresholds, control various actuators. For example, the compute DCN 110 may monitor various sensors 118 to ascertain data about chemical levels, flow rates (e.g., across valves), tank temperatures, control rates, etc., and may control one or more actuators 116 based on these data and/or comparisons of these data to various criteria and/or thresholds. For instance, compute DCN 110-N can control actuator 116-4 by transmitting, to DCN 110-4, corresponding command(s) that can optionally conform to a protocol that is specific to DCN 110-4.

Many DCNs may host multiple resources such as physical I/O components and/or function blocks. Consequently, these DCNs may include multiple I/O channels and/or function blocks that can be accessed, e.g., by other devices or systems such as other DCNs, GDS 104, alias pub/sub module 107, etc. For example, each DCN 110 may host a cross-platform server, such as an OPC UA server, that provides access to various resources hosted by the DCN 110, including the DCN’s I/O channels and/or function blocks. A cross-platform client application, such as an OPC UA client operating on a DCN 110, may connect to a cross-platform server hosted by the DCN so that it can read data from input channels associated with, for instance, sensors such as FT components 114, sensors 118, function blocks, etc. Likewise, the client application may connect to the server hosted by the DCN to write data to output channels, e.g., to provide control signals or commands to actuators 116.

As noted above, tracking the myriad data sources (e.g., I/O channels and/or other data sources such as function blocks) of DCNs deployed across a complex process automation facility 108 using typical connection strings (e.g., networking information plus node IDs) may present various challenges. Connection strings of individual nodes, which may include Internet Protocol (IP) addresses and/or Transmission Control Protocol (TCP) ports, as well as node IDs used to identify individual components that are accessible via those nodes, are not readily interpretable by or meaningful to humans, and do not easily scale. Hence, GDS 104 is used to assign human-interpretable and/or meaningful aliases to the various data sources made available by the DCNs.

Implementations described herein can be implemented using components of FIG. 1 to maintain QoS of a cross-platform server such as an OPC UA server in a process automation facility. Each of the N DCNs 110 may host an OPC UA server that manages access to its I/O channels, such as those coupled to FT components 114 and actuators 116. A compute DCN 110-N may subscribe to these channels, enabling it to implement a process control loop. If a particular OPC UA server, say hosted by DCN 110-1, becomes overloaded, process automation management system 102 can assign a higher priority to compute DCN 110-N, thereby ensuring the compute DCN 110-N continues to receive data from the OPC UA server hosted by DCN 110-1 to maintain proper operation of the process control loop. Prioritization can be implemented in several ways, such as prioritizing transmission of data packets or throttling network traffic from lower-priority subscribers. Additionally, priority assignments can be managed by OPC UA servers or by applications running on top of them, allowing function blocks subscribing to resources to self-assign priorities. This ensures that critical nodes of the process automation facility receive the necessary data, even during periods of high server load.

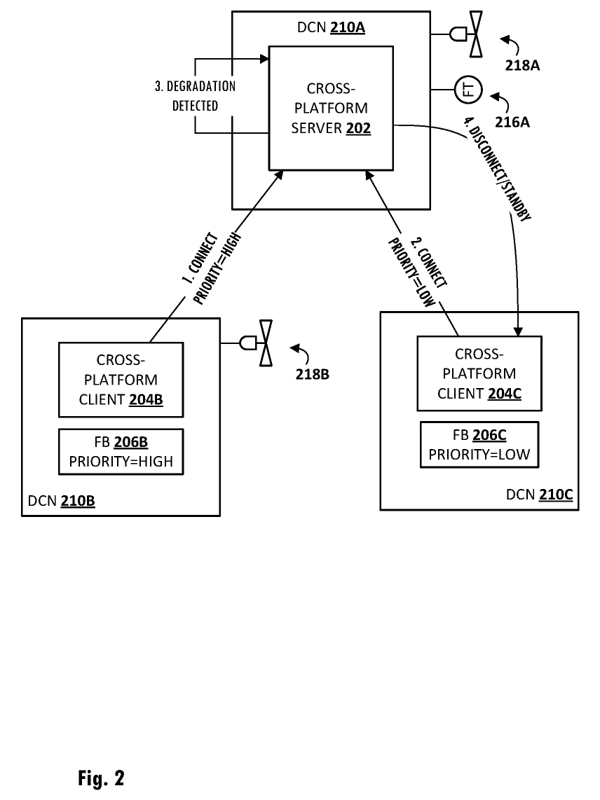

FIG. 2 schematically depicts an example of how techniques described herein may be implemented between a cross-platform server 202 (e.g., an OPC UA server) hosted by a first DCN 210A and two cross-platform clients 204B-C hosted by two subscribing DCNs 210B-C. In this example, first DCN 210A includes an FT component 216A and an actuator 218A. Second DCN 210B hosts platform dependent client 204B (e.g., an OPC UA client) and a first function block 206B, and includes a second actuator 218B. Third DCN 210C hosts another cross-platform client 204C and another function block 206C, and does not include any sensors or actuators.

The arrows 1-4 in FIG. 2 demonstrate an example of how techniques described herein may be implemented. At arrow 1, cross-platform client 204B connects (or "subscribes") to cross-platform server 202 and indicates that its function block 206B has a priority of "high." This priority designation may indicate that, for instance, the control of second actuator 218B by function block 206B based on signal(s) from FT component 216A is highly critical for a process control loop.

At arrow 2, cross-platform client 204C operating on DCN 210C connects (or "subscribes") to cross platform server 202 and indicates that its function block 206C has a priority of "low." This priority designation may indicate, for instance, that the control of function block 206C based on signal(s) from FT component 216A is less critical for the process control loop. For example, DCN 210C may be a compute node that is configured to gather operational statistics for future analysis, or DCN 210C may be a "debugging" node that is intended to facilitate monitoring and debugging.

At arrow 3, cross-platform server 202 detects a degradation in operation. This degradation can come in various forms, including but not limited to a sudden increase in a number of connections to cross-platform server 202; an increase in a frequency of data or event requests; an increase in a load on cross-platform server 202 that is above a threshold; and/or a partial failure of cross-platform server 202, to name a few examples.

In some implementations, a machine learning model may be trained to detect performance degradation of the cross-platform server 202 by analyzing various metrics such as CPU utilization, memory usage, network latency, and/or the number of active client connections. For instance, a neural network could be trained using historical performance data to predict future degradation based on current system states. Long Short-Term Memory (LSTM) networks could be particularly effective at capturing temporal dependencies in the performance data, enabling the detection of subtle patterns that precede degradation. Additionally, Large Language Models (LLMs) could analyze server logs and system events to identify anomalies indicative of performance issues. By training an LLM on extensive log data, the LLM could learn to recognize patterns and correlations that are difficult for humans to detect, such as specific error messages, unusual access patterns, or resource contention scenarios.

In response to detecting the operational degradation, at arrow 4, cross-platform server 202 terminates (at least temporarily) its connection to DCN 210C having the lower priority function block 206C. In other implementations, instead of terminating the connection, cross-platform server 202 may instruct cross-platform client 204C and/or function block 206C to standby until further notice (e.g., until the operational degradation is no longer detected). In yet other implementations, cross-platform server 202 may continue to allow cross-platform client 204C and/or function block 206C to read data, but at a throttled rate.

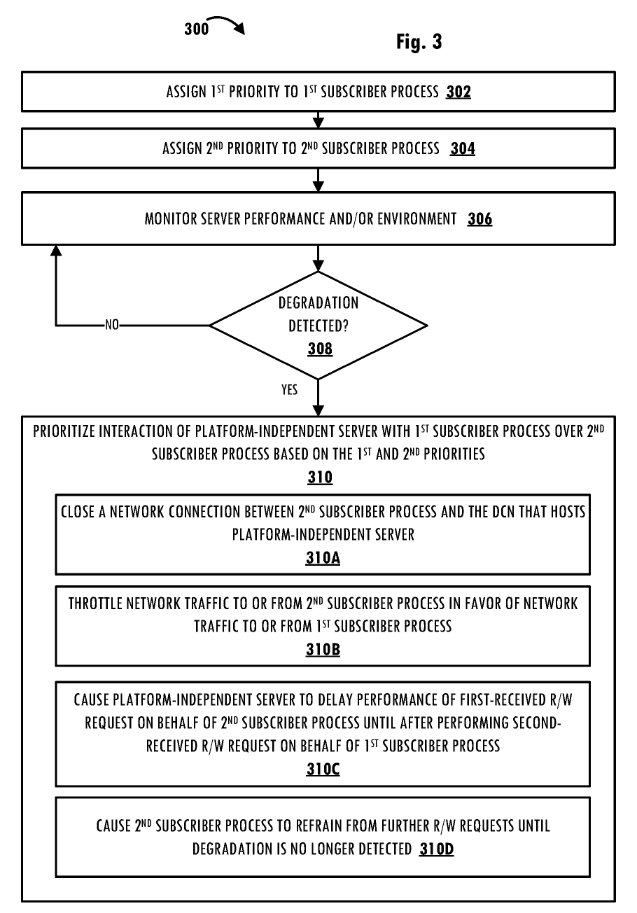

FIG. 3 schematically depicts a method 300 for practicing selected aspects of the present disclosure. For convenience, FIG. 3 is described in relation to a system, namely, a cross-platform server (e.g., 202). However, method 300 may be implemented by any suitable system and/or any of the other systems described herein. In some implementations, method 300 may be implemented on one or more computer systems that implement GDS 104, alias pub/sub module 107, GDS database 105, and/or one or more DCNs 110.

At block 302, the system may assign a first priority to a first subscriber process, such as a cross-platform client (e.g., 204A, 204B), which as stated previously may take the form of an OPC UA client in some cases. The first subscriber process subscribes to one or more I/O channels managed by a platform-independent server (e.g., 202), which may be an OPC UA server hosted by a DCN (e.g., 110, 210) of a process automation facility. The I/O channels may include sensors, actuators, and/or function blocks. In some implementations, the first priority is assigned to the first subscriber process on the basis of the first subscriber using data it obtains from one or more of the I/O channels to control an actuator 116 in a process control loop of the process automation facility 108.

At block 304, the system may assign a second priority to a second subscriber process. The second subscriber process subscribes to one or more of the I/O channels hosted by the platform-independent server hosted by the distributed control node and the second priority may be lower than the first priority. In some implementations, the second priority may be assigned to the second subscriber process on the basis of the second subscriber process using data it obtains from one or more of the I/O channels to perform non-essential task(s), such as documenting, debugging, reporting, etc. In some implementations, the first subscriber process assigns itself the first priority, and/or the second subscriber process assigns itself the second priority.

At block 306, the system may monitor performance of the cross-platform server and/or the environment around it. For example, the system may monitor network congestion on one or more network hops used frequently by the cross-platform server. As another example, the cross-platform server may monitor a number of subscribers it supports at any given moment, and/or the amount of resource usage by the cross-platform server and/or any of its subscribers. Other examples of performance measurements that the system may gather are also possible.

At block 308, the system may determine whether the platform-independent server is experiencing a degradation in performance. The determining may include detecting that a number of network connections to the DCN that hosts the platform-independent server satisfies a threshold. Additionally or alternatively, the determining may include detecting that the second subscriber process has submitted read or write requests at a frequency that satisfies a threshold.

In some implementations, a machine learning model may be trained to detect performance degradation of the platform-independent server by analyzing various metrics. Using a feedforward neural network, historical data comprising server load, network traffic, CPU utilization, memory usage, the number of connected clients, and/or the frequency of read/write requests could be used as input features. The output layer could be a binary classification indicating whether the server is in a normal state or a degraded state, a multi-class output classifying the performance into one of multiple tiers or ranges (or bins) of performance, continuous output, etc. The model could be trained, for instance, using labeled data, where the labels are determined based on predefined thresholds for acceptable performance. The model can then predict the likelihood of performance degradation in real-time.

Alternatively, single or multimodal large language models (LLMs) can be employed for degradation detection, especially when log data is available. A single LLM could be trained on server logs to identify patterns and anomalies that correlate with performance degradation. A multimodal LLM could combine server logs with other data sources, such as system metrics, event logs, images (e.g., of exhausts, sensor readouts, etc.) and even maintenance records, to provide a more comprehensive assessment. The LLM could be trained to classify server states or to generate alerts when specific patterns indicative of degradation are identified. Fine-tuning these models with domain-specific data (e.g., OPC UA server logs) would further enhance their accuracy and relevance.

Referring back to FIG. 3, if the answer at block 308 is no, then method 300 may return to block 306. However, if the answer at block 308 is yes, then method 300 may proceed to block 310. At block 310, the system may prioritize interaction of the platform-independent server with the first subscriber process over the second subscriber process based on the first and second priorities, in response to the determination that the server is experiencing a degradation in performance. The prioritizing may be performed in various ways, such as by closing a network connection between the second subscriber process and the DCN that hosts the platform-independent server at block 310A. This may be done in extreme cases where, for instance, a lower priority subscriber is negatively impacting the overall fitness of the server by requesting too many operations.

Additionally or alternatively, at block 310B, the prioritizing may include throttling network traffic to or from the second subscriber process in favor of network traffic to or from the first subscriber process. Additionally or alternatively, at block 310C, the prioritizing may include causing the platform-independent server to delay performance of a first-received read or write request on behalf of the second subscriber process until after performing a second-received read or write request on behalf of the first subscriber process. Additionally or alternatively, at block 310D, the prioritizing may include causing the second subscriber process to refrain from further read or write requests until the degradation is no longer detected.

As one non-limiting example of how techniques described herein may be implemented, consider an oil refinery where real-time monitoring of a catalyst slurry mixture is critical for optimizing reactor performance. Multiple sensors, such as temperature, pressure, and density sensors, are deployed throughout the slurry processing unit, each with corresponding aliases managed by an OPC UA server. A control system monitors these sensors and adjusts the flow rates of various components of the slurry via control valves. A first subscriber process monitors the performance of the reactors and adjusts the catalyst slurry ratios. Due to the critical role played by the performance and adjustments, this process is assigned a high priority. Now assume that there's another subscriber that has a low priority to monitor the temperature profile within the lines conveying the slurry. An example is where there is an abundance of wax in the pipes and it is desired to maintain the line temperature at a higher range so that wax buildup does not inhibit the slurry from flowing. Should the load on the OPC UA server be elevated for any reason, the first subscriber is prioritized to keep catalyst slurry ratios optimal, rather than addressing wax inhibitions and/or temperature performance along slurry transportation lines.

Consider another example from a pharmaceutical manufacturing plant focusing on continuous drug manufacturing. In this plant, precise control of mixing, reaction, and purification steps is crucial. Consider a scenario where two temperature sensors, one measuring the reactor temperature (critical for reaction kinetics) and another monitoring the cooling jacket temperature (less critical but important for preventing overheating), are connected to an OPC UA server on a DCN. Client applications subscribe to these sensors via OPC UA. The primary client application is a PID (proportional-integral-derivative) controller that dynamically adjusts the heating or cooling of the reactor to maintain the setpoint temperature essential for a correct reaction. This client would be assigned a “high” priority, given the immediate need to control the reaction.

There could also be an edge computing-based application which makes slow, regular requests of the server's data which are not essential to the control of the reactors and which can operate with intermittent connectivity. This application would be given "low" priority. If the OPC UA server on the DCN experiences an overload, perhaps due to a network issue or a sudden spike in requests from diagnostic applications, the OPC UA server will prioritize the PID controller, ensuring the reaction temperature stays tightly controlled. To manage OPC UA degradation this might include: 1) delay processing or drop requests from lower-priority client if it exceeds its provisioned allocation of resources; 2) reducing/throttling back non-essential read/write requests; and/or 3) temporarily closing network connection to the edge application to maintain real-time critical system. By implementing such prioritization, the pharmaceutical plant ensures consistent QoS for its most critical processes, such as reactions where product can be lost, and reduced risk of batches of costly pharmaceutical intermediates being spoiled or degraded.

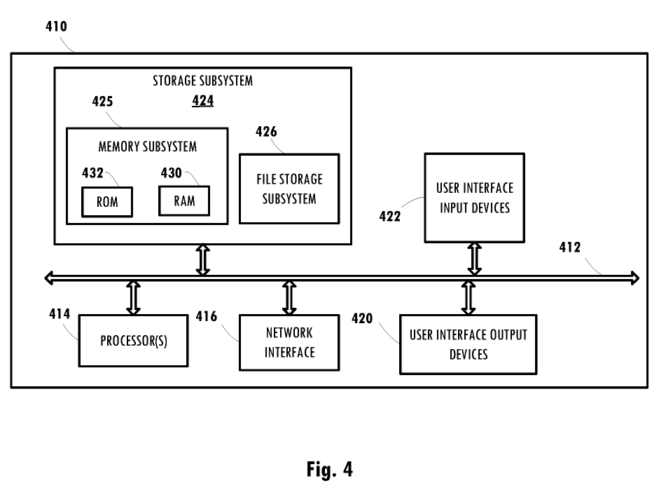

FIG. 4 is a block diagram of an example computer system 410. Computer system 410 typically includes at least one processor 414 which communicates with a number of peripheral devices via bus subsystem 412. These peripheral devices may include a storage subsystem 424, including, for example, a memory subsystem 425 and a file storage subsystem 426, user interface input devices 422, user interface output devices 420, and a network interface subsystem 416. The input and output devices allow user interaction with computer system 410. Network interface subsystem 416 provides an interface to outside networks and is coupled to corresponding interface devices in other computer systems.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 410 to the user or to another machine or computer system.

Memory 425 used in the storage subsystem can include a number of memories including a main random-access memory (RAM) 430 for storage of instructions and data during program execution and a read only memory (ROM) 432 in which fixed instructions are stored. A file storage subsystem 426 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 426 in the storage subsystem 424, or in other machines accessible by the processor.

Bus subsystem 412 provides a mechanism for letting the various components and subsystems of computer system 410 communicate with each other as intended. Although bus subsystem 412 is shown schematically as a single bus, alternative implementations of the bus subsystem may use multiple busses.

Computer system 410 can be of varying types including a workstation, server, computing cluster, blade server, server farm, or any other data processing system or computing device. Due to the ever-changing nature of computers and networks, the description of computer system 410 depicted in FIG. 4 is intended only as a specific example for purposes of illustrating some implementations. Many other configurations of computer system 410 are possible having more or fewer components than the computer system depicted in FIG. 4.

In various implementations, a method implemented using one or more processors may include assigning a first priority to a first subscriber process and a second, lower priority to a second subscriber process. The subscribers may access I/O channels managed by a platform-independent server hosted by a distributed control node of a process automation facility. Should the platform-independent server experience a degradation in performance, interaction of the platform-independent server with the first subscriber process may be prioritized over that with the second subscriber process.

In some implementations, the first priority may be assigned to the first subscriber process based on the first subscriber using data obtained from the I/O channels to control an actuator in a process control loop. In some implementations, the second priority may be assigned to the second subscriber process based on the second subscriber process using data obtained from the I/O channels to perform debugging.

The prioritizing may comprise closing a network connection between the second subscriber process and the DCN that hosts the platform-independent server. In some implementations, the prioritizing may comprise throttling network traffic to or from the second subscriber process in favor of network traffic to or from the first subscriber process. In some implementations, the prioritizing may comprise causing the platform-independent server to delay performance of a first-received read or write request on behalf of the second subscriber process until after performing a second-received read or write request on behalf of the first subscriber process. In some implementations, the prioritizing may comprise causing the second subscriber process to refrain from further read or write requests until the degradation is no longer detected.

In some implementations, the first subscriber process may assign itself the first priority. In some implementations, the second subscriber process may assign itself the second priority.

The determining that the platform-independent server is experiencing a degradation in performance may include detecting that a number of network connections to the DCN that hosts the platform-independent server satisfies a threshold. Additionally or alternatively, the determining may comprise detecting that the second subscriber process has submitted read or write requests at a frequency that satisfies a threshold.

In some implementations, a system may include one or more processors and memory storing instructions that, when executed by the processors, may cause the processors to assign a first priority to a first subscriber process and a second, lower priority to a second subscriber process. The subscribers may access I/O channels managed by a platform-independent server hosted by a distributed control node of a process automation facility. Should the platform-independent server be determined as experiencing a degradation in performance, interaction of the platform-independent server with the first subscriber process may be prioritized over the second subscriber process.

In some implementations, the first priority may be assigned to the first subscriber process based on the first subscriber using data it obtains from the I/O channels to control an actuator in a process control loop. In some implementations, the second priority may be assigned to the second subscriber process based on the second subscriber process using data it obtains from the I/O channels to perform debugging.

The instructions to prioritize may comprise instructions to close a network connection between the second subscriber process and the DCN that hosts the platform-independent server. In some implementations, the instructions to prioritize may comprise instructions to throttle network traffic to or from the second subscriber process in favor of network traffic to or from the first subscriber process. In some implementations, the instructions to prioritize may comprise instructions to cause the platform-independent server to delay performance of a first-received read or write request on behalf of the second subscriber process until after performing a second-received read or write request on behalf of the first subscriber process. In some implementations, the instructions to prioritize may comprise instructions to cause the second subscriber process to refrain from further read or write requests until the degradation is no longer detected.

In some implementations, the first subscriber process may assign itself the first priority. In some implementations, the second subscriber process may assign itself the second priority. In some implementations, the determining may include detecting that a number of network connections to the DCN that hosts the platform-independent server satisfies a threshold. Additionally or alternatively, in some implementations, the determining may include detecting that the second subscriber process has submitted read or write requests at a frequency that satisfies a threshold.

In some implementations, the methods described above may be carried out by a system that includes at least one non-transitory computer-readable storage medium, the computer-readable storage medium storing program instructions that when executed by at least one processor cause the at least one processor to carry out the method. In yet other implementations, a computer system may include at least one processor and at least one computer-readable storage medium storing program instructions that when executed by the at least one processor cause the at least one processor to carry out the method.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors and comprising:
assigning a first priority to a first subscriber process that subscribes to one or more input/output (I/O) channels managed by a platform-independent server hosted by a distributed control node (DCN) of a process automation facility, wherein the one or more I/O channels comprise one or more of a sensor or an actuator;
assigning a second priority to a second subscriber process that subscribes to one or more of the I/O channels hosted by the platform-independent server hosted by the DCN, wherein the second priority is lower than the first priority;
determining that the platform-independent server is experiencing a degradation in performance; and
in response to the determining, and based on the first and second priorities, prioritizing interaction of the platform-independent server with the first subscriber process over the second subscriber process.

2. The method of claim 1, wherein the first priority is assigned to the first subscriber process on the basis of the first subscriber using data it obtains from one or more of the I/O channels to control an actuator in a process control loop of the process automation facility.

3. The method of claim 1, wherein the second priority is assigned to the second subscriber process on the basis of the second subscriber process using data it obtains from one or more of the I/O channels to perform debugging.

4. The method of claim 1, wherein the prioritizing comprises closing a network connection between the second subscriber process and the DCN that hosts the platform-independent server.

5. The method of claim 1, wherein the prioritizing comprises throttling network traffic to or from the second subscriber process in favor of network traffic to or from the first subscriber process.

6. The method of claim 1, wherein the prioritizing comprises causing the platform-independent server to delay performance of a first-received read or write request on behalf of the second subscriber process until after performing a second-received read or write request on behalf of the first subscriber process.

7. The method of claim 1, wherein the prioritizing comprises causing the second subscriber process to refrain from further read or write requests until the degradation is no longer detected.

8. The method of claim 1, wherein the first subscriber process assigns itself the first priority.

9. The method of claim 1, wherein the second subscriber process assigns itself the second priority.

10. The method of claim 1, wherein the determining comprises detecting that a number of network connections to the DCN that hosts the platform-independent server satisfies a threshold.

11. The method of claim 1, wherein the determining comprises detecting that the second subscriber process has submitted read or write requests at a frequency that satisfies a threshold.

12. A system comprising one or more processors and memory storing instructions that, in response to execution by the one or more processors, cause the one or more processors to:
assign a first priority to a first subscriber process that subscribes to one or more input/output (I/O) channels managed by a platform-independent server hosted by a distributed control node (DCN) of a process automation facility, wherein the one or more I/O channels comprise one or more of a sensor or an actuator;
assign a second priority to a second subscriber process that subscribes to one or more of the I/O channels hosted by the platform-independent server hosted by the DCN, wherein the second priority is lower than the first priority;
determine that the platform-independent server is experiencing a degradation in performance; and
in response to the determination that the platform-independent server is experiencing a degradation in performance, and based on the first and second priorities, prioritize interaction of the platform-independent server with the first subscriber process over the second subscriber process.

13. The system of claim 12, wherein the first priority is assigned to the first subscriber process on the basis of the first subscriber using data it obtains from one or more of the I/O channels to control an actuator in a process control loop of the process automation facility.

14. The system of claim 12, wherein the second priority is assigned to the second subscriber process on the basis of the second subscriber process using data it obtains from one or more of the I/O channels to perform debugging.

15. The system of claim 12, wherein the instructions to prioritize comprise instructions to close a network connection between the second subscriber process and the DCN that hosts the platform-independent server.

16. The system of claim 12, wherein the instructions to prioritize comprise instructions to throttle network traffic to or from the second subscriber process in favor of network traffic to or from the first subscriber process.

17. The system of claim 12, wherein the instructions to prioritize comprise instructions to cause the platform-independent server to delay performance of a first-received read or write request on behalf of the second subscriber process until after performing a second-received read or write request on behalf of the first subscriber process.

18. The system of claim 12, wherein the instructions to prioritize comprise instructions to cause the second subscriber process to refrain from further read or write requests until the degradation is no longer detected.

19. The system of claim 12, wherein the first subscriber process assigns itself the first priority.

20. At least one non-transitory computer-readable medium comprising instructions that, in response to execution of the instructions by one or more processors, cause the one or more processors to perform the following operations:
assign a first priority to a first subscriber process that subscribes to one or more input/output (I/O) channels managed by a platform-independent server hosted by a distributed control node (DCN) of a process automation facility, wherein the one or more I/O channels comprise one or more of a sensor or an actuator;
assign a second priority to a second subscriber process that subscribes to one or more of the I/O channels hosted by the platform-independent server hosted by the DCN, wherein the second priority is lower than the first priority;
determine that the platform-independent server is experiencing a degradation in performance; and
in response to the determination that the platform-independent server is experiencing a degradation in performance, based on the first and second priorities, prioritize interaction of the platform- independent server with the first subscriber process over the second subscriber process.
